(19) United States
(12) Patent Application Publication
(10) Pub. No.: US 2009/0104012 A1
(43) Pub. Date: Apr. 23, 2009

(54) GRAPPLE ATTACHMENT

(75) Inventor: Timothy E. Daniel, Carlock, IL (US)

Correspondence Address: HUSCH BLACKWELL SANDERS LLP, 190 CARONDELET PLAZA, SUITE 600, ST. LOUIS, MO, 63105-3441, US

(73) Assignee: Daniel Manufacturing, Inc., Carlock, IL (US)

(21) Appl. No.: 11/877,024

(22) Filed: Oct. 23, 2007

(51) Int. Cl. B66C 1/44

(52) U.S. Cl. 414/729

(57) ABSTRACT

A fork and jaw grapple attachment having two forks and a jaw for wedging under, prying up, gripping, moving and handling materials. The forks have tips with angles for prying between and under materials. The jaw being a hydraulically actuated upper jaw that moves about a pivot point via a cylinder for grabbing, gripping and holding materials during pick-up, transport and place down.

### CROSS-REFERENCE TO RELATED APPLICATIONS

This application claims priority from U.S. patent application Ser. No. 10/840,005 filed May 6, 2004 now U.S. Pat. No. 7,014,412 issued on Mar. 21, 2006.

### BACKGROUND OF THE INVENTION

1. Field of the Invention

The present invention relates to a device for gripping, moving and handling materials and, more particularly, to a fork and jaw grapple for operatively attaching to a skid steer loader or other equipment.

2. Related Art

Installation of new or different utility lines, services or plumbing into preexisting facilities often present workers with the necessity of breaking preexisting hard ground surfaces such as black top, concrete slab driveways and sidewalks, or poured concrete floors. In order to create a trench for proper burial of a service line, workmen must first break through the preexisting concrete or blacktop pavement.

Preexisting tools for this purpose include air spades or tools designed to take up large portions of blacktop or pavement, for anticipated removal of the entire ground covering. See for example, U.S. Pat. No. 7,014,412. Prior art tools such as jack hammers or air spades are too labor intensive and to imprecise for quickly breaking through a concrete or blacktop surface to create a trench. More powerful hydraulic tools designed to be attached to skid steers or excavators lack the precision to create a trench through blacktop or concrete as their structure is designed to take up large sections of blacktop or concrete.

There is a need in the art for a hydraulic tool mountable on a skid steer, excavator or other self-propelled construction machine that can break up blacktop or concrete across a long section with narrow precision for a trench to be created underneath.

### SUMMARY OF THE INVENTION

An aspect of the present invention is to provide an apparatus for overcoming one or more of the problems set forth above.

Thus, in furtherance of the above goals and advantages, the present invention is a grapple attachment. The grapple attachment has one lower fork, an upper jaw pivotably connected to the lower fork, and a hydraulic cylinder operatively connected to the upper jaw. The hydraulic cylinder is adapted to pivot the upper jaw relative to the lower fork. The lower fork has a longitudinally extending member with an arcuate portion located at an end portion of the longitudinally extending member such that the arcuate portion may provide a fulcrum point and the longitudinally extending member provides a lever for mechanical advantage.

The present invention having a single lower jaw that is substantially aligned with its single upper jaw provides for breaking, separating, leveraging and lifting long thin pieces of blacktop or concrete properly dimensioned for creating a trench under a hard ground surface.

These, and other aspects and advantages of the present invention, will become apparent from the following detailed description. The above listing of aspects of the invention should not be deemed as all-inclusive in any manner whatsoever.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

The accompanying drawings, which are incorporated in and form a part of the specification, illustrate the embodiments of the present invention and together with the description, serve to explain the principles of the invention. In the drawings:

FIG. 1 is a side view of a fork and jaw grapple according to the present invention;

FIG. 2 is a front view of the fork and jaw grapple;

FIG. 3 is a top view of the fork and jaw grapple;

FIG. 4 is a back view of the fork and jaw grapple;

FIG. 5 is a side view of the fork and jaw grapple showing a cross-sectional view of the jaw according to 5-5 of FIG. 3;

FIG. 6 is a side view of the fork and jaw grapple showing a cross-sectional view of the fork according to 6-6 of FIG. 3; and

FIG. 7 is a side view of a skid steer loader.

### DETAILED DESCRIPTION OF THE PREFERRED EMBODIMENTS

The following description of the preferred embodiment(s) is merely exemplary in nature and is in no way intended to limit the invention, its application, or uses.

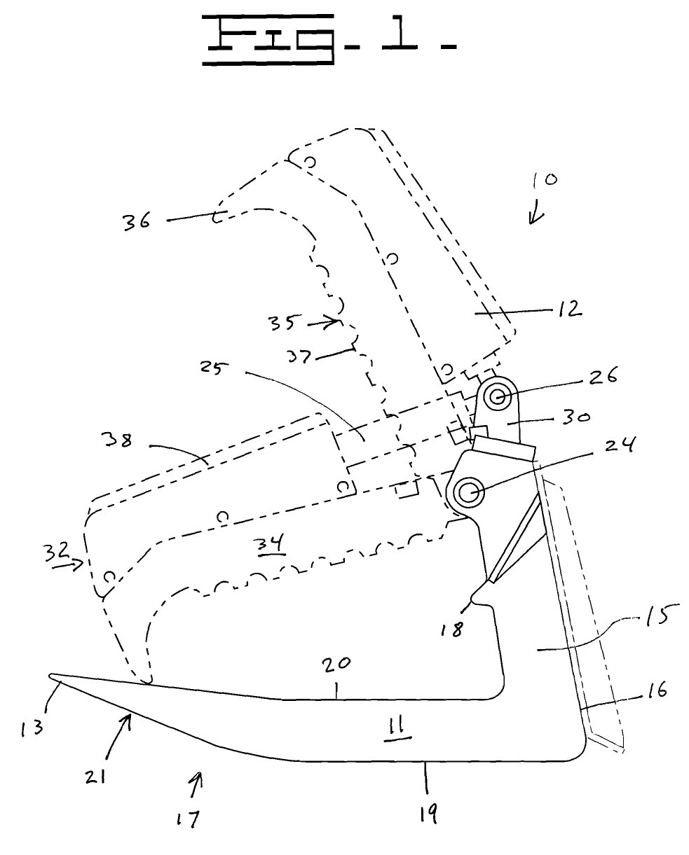

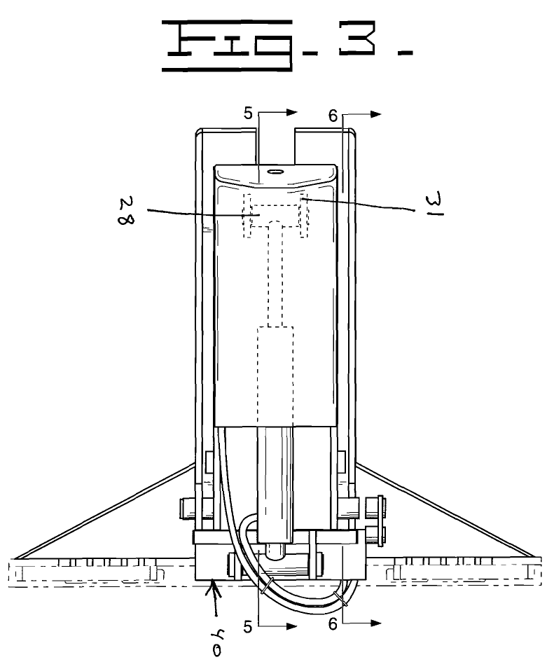

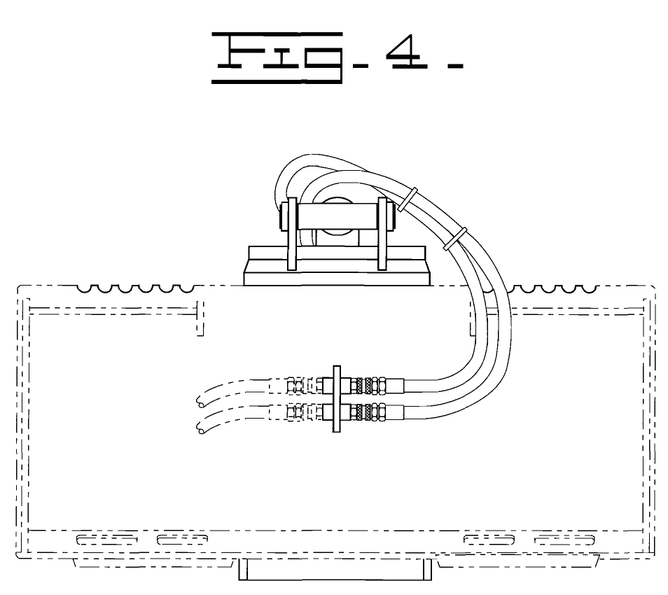

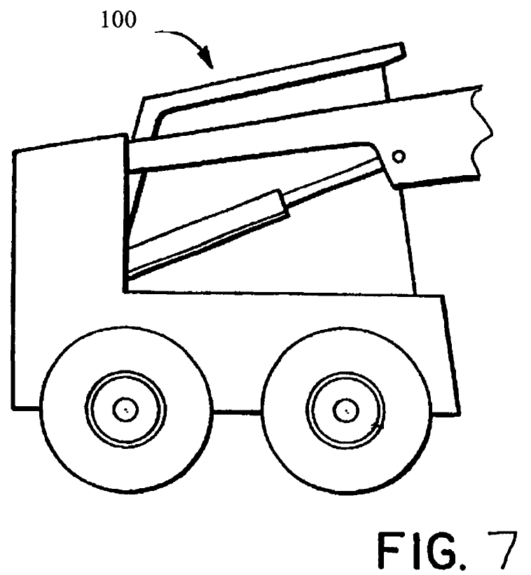

Referring to the accompanying drawings in which like reference numbers indicate like elements, FIGS. 1-6 illustrate a fork and jaw grapple 10 for use on a vehicle, for example a skid steer loader 100 (see FIG. 7). The fork and jaw grapple 10 has a fork 11 and a jaw 12. The fork 11 and jaw 12 are made from high strength steel. Tip 13 of the fork 11 may be made of high carbon steel.

In the depicted embodiment, the fork 11 is L-shaped. The fork 11 has a width from outer edge to outer edge of about 7 inches. In the fork and jaw grapple's 10 resting position as shown in FIGS. 1, 5 and 6, the fork 11 extends substantially parallel with a horizontal plane for approximately nine (9) inches from back surfaces 16 of upward extending members 15 of the fork 11. Thereafter, the fork 11 has curvatures 17 which may be used for prying and getting under heavy objects. The curvatures 17 extend approximately nine (9) inches. There is a twenty-two (22°) degree angle between a tapered portion 21 of the fork 11 and horizontal plane or bottom surface 19 of the fork 11. The back surface 16 of the upward extending members 15 is eighty-three (83°) degrees from the bottom surface 19 of the fork 11. The fork 11 is eighteen (18) inches in length from the back surface 16 of the upward extending member 15 to the end of the fork 11. The upward extending member 15 may have at least one stop 18 for precluding upward movement of objects being carried or moved by the fork and jaw grapple 10. The stop 18 is approximately three (3) inches from top surfaces 20 of the fork 11 in the depicted embodiment.

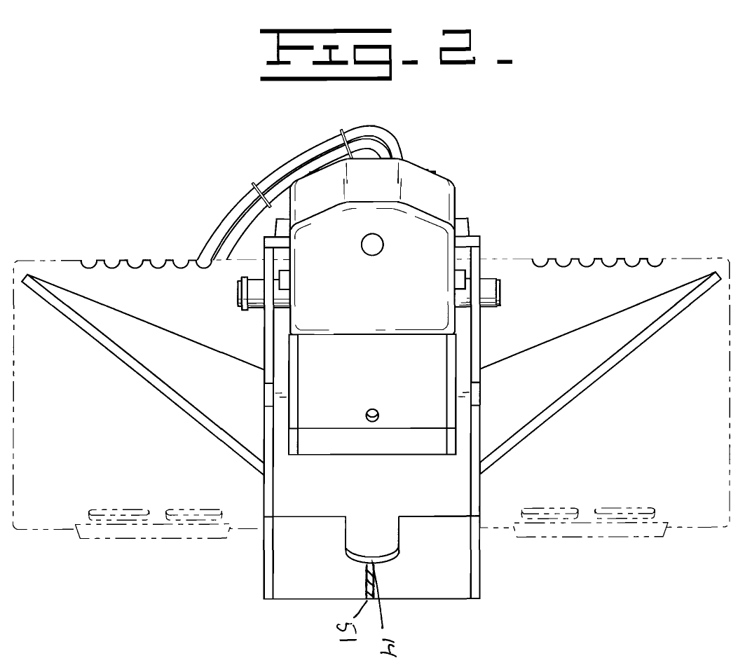

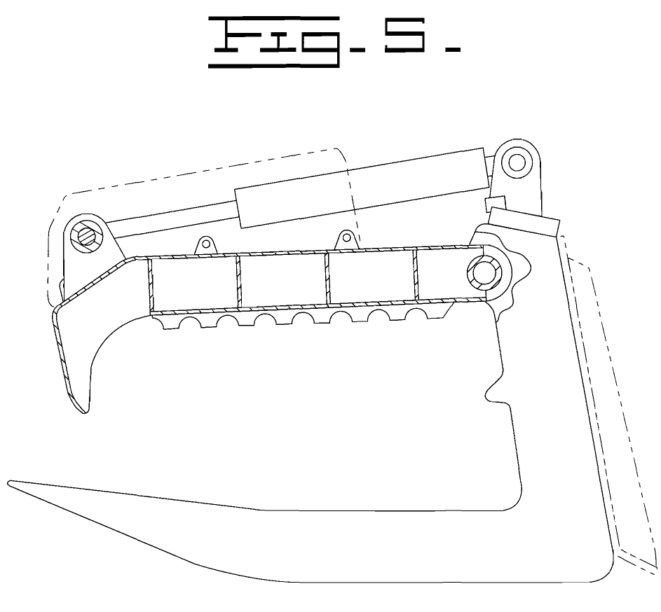

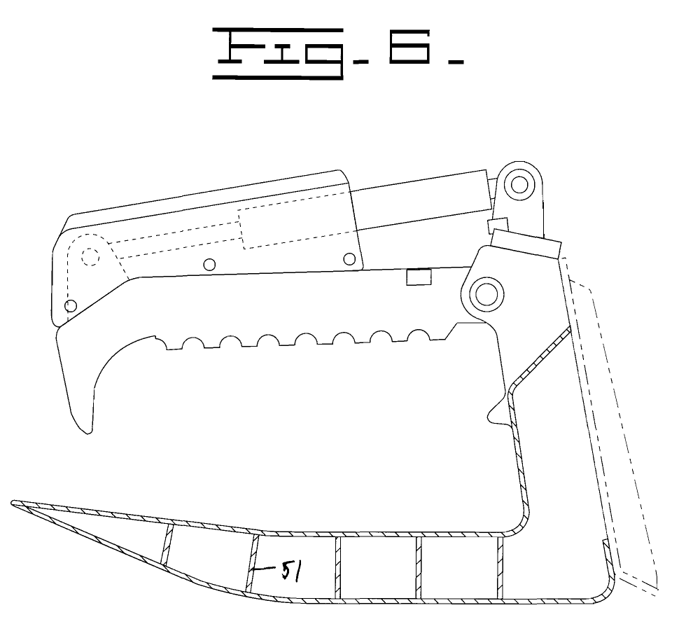

The lower fork is box construction. It consists of two side plates, each one-half inch thick and a top and bottom plate, each one-quarter inch thick. The bottom fork is two inches deep, from top to bottom. The interior of the lower fork may include baffles 51 such as are depicted in FIG. 6. It is within the scope of the invention that the baffles may run side to side as depicted, or in other directions, such as a longitudinal baffle 51 as shown in FIG. 2. Similar box like construction may be used for manufacturing the upper jaw, as seen in FIG. 5.

The curvatures 17 and shape of the fork 11 magnify the “breakout” or upward force that can be exerted by the fork and jaw grapple 10. This is significant because a skid steer loader is limited in the amount of upward force it can apply on an object. The width of the fork and jaw grapple 10 is narrower than a full-length or width bucket attachment commonly used on a skid steer loader so that the fork 11 is within the width of concrete slabs to facilitate the prying up and carrying of narrow, trench-wide portions of concrete slabs. The narrowness of the fork and jaw grapple 10 is significant and advantageous over a full-length or width bucket attachment because it concentrates the limited effort of the skid steer loader in front of and close to the center line of the machine. Moreover, the narrower width allows the skid steer loader to maneuver in tight spots or corners. The skid steer loader with the fork and jaw grapple 10 attached thereto enables the operator to steer or track straight in and out in-line with a trench line. In contrast, when a full-length or width bucket is used to remove a slab of concrete from a sidewalk, the corner of a bucket would be used to pry up the slab which commonly leads to equipment failure and defect and significant disruption of the surrounding soil and concrete. As examples, the fork and jaw grapple 10 may have a width less than the width of a machine frame, or a width substantially narrower, such as the eight inches in the depicted embodiment. It should be noted that the previously described dimensions of the fork and jaw grapple 10 are beneficial for trenching under concrete slabs and other materials; however, the dimensions may be varied.

In the depicted embodiment, the front edge 13 includes a cut out 14 which may be advantageous for prying or trenching.

Referring now to FIGS. 1, 5 and 6, the jaw 12 is a hydraulically actuated upper jaw and moves about a pivot point 24 via a cylinder 25. The jaw 12 has a range of motion about the pivot point 24. The jaw 12 has an arm 34 having a straight portion 35 and a curved end 36. The curved end 36 curves downwardly when in the resting position. The curved end 36 facilitates the grabbing or holding of materials or objects and precludes materials or objects from slipping out of the fork and jaw grapple 10 during transport. The jaw 12 moves about the pivot point 24 and provides a holding or clamping force on materials or objects. The straight portion 35 of the arm 34 has fingers 37 for gripping and holding materials or objects.

The cylinder 25 has a two (2) inch bore diameter and four and three-quarters (4¾) inch stroke length. The cylinder 25 is housed in a shroud 38 to protect it from damage during use and inclement weather. The shroud 38 is operatively connected to the jaw 12. The cylinder 25 has a first end 27 operatively connected to a first horizontal pin 26, and a second end 29 operatively connected to a second horizontal pin 28. The first horizontal pin 26 is rotatably mounted to a back mounting bracket 30, and the second horizontal pin 28 is rotatably mounted to a front mounting bracket 31. The front mounting bracket 31 is operatively mounted to a front, top end 32 of the jaw 12. The back mounting bracket 30 is operatively attached to the mount assembly 40 at a top portion 33. The pivot point 24 of the jaw 12 is offset from the first horizontal pin 26 of the cylinder 25 in the vertical and horizontal axis, and the second horizontal pin 28 is offset from the pivot point 24 and the first horizontal pin 26 in the vertical and horizontal axis such that when the cylinder extends and retracts, the jaw 12 rotates about the first horizontal pin 26 as indicated by the phantom lines in FIG. 1. Specifically, as the second end 29 of the cylinder 25 extends, the jaw 12 moves or pivots about the pivot point 24 in the downward direction towards the fork 11, and as the second end 29 of the cylinder 25 retracts, the jaw 12 moves or pivots about the pivot point 24 in the upward direction away from the fork 11.

In one embodiment, the present invention is a fork and grapple attachment for a machine having a machine frame. The fork and jaw grapple attachment includes a single lower fork, an upper jaw pivotably connected to the lower fork, and a hydraulic cylinder operatively connected to the upper jaw. The upper jaw includes an arm having an arcuate end portion at a distal end of the arm. The lower fork has a longitudinally extending member, an upwardly extending back member transverse to the longitudinally extending member, an arcuate portion located at an end portion of the longitudinally extending member, and a tapered portion operatively connected to the arcuate portion.

In another embodiment, the present invention is a fork and grapple attachment for a machine having a machine frame. The fork and jaw grapple attachment includes a single lower fork, an upper jaw pivotably connected to the lower fork and a hydraulic cylinder operatively connected to the upper jaw. The upper jaw includes an arm having an arcuate end portion at a distal end of the arm. The lower fork has a longitudinally extending member, an upwardly extending back member transverse to the longitudinally extending member, an arcuate portion located at an end portion of the longitudinally extending member, and a tapered portion operatively connected to the arcuate portion such that the arcuate portion provides a fulcrum point and the longitudinally extending member provides a lever for mechanical advantage. A width between outside edges of the lower fork is dimensioned for trenching through a slab of concrete or blacktop. The width may be dimensioned to adapt to the width of a typical service trench.

In yet another embodiment, the present invention is a skid steer loader having a machine frame. The skid steer loader includes an attachment. The attachment includes a single lower fork, an upper jaw pivotably connected to the lower fork, and a hydraulic cylinder operatively connected to the upper jaw. The upper jaw includes an arm having an arcuate end portion at a distal end of the arm. The lower fork has a longitudinally extending member, an upwardly extending back member transverse to the longitudinally extending member, an arcuate portion located at an end portion of the longitudinally extending member, and a tapered portion operatively connected to the arcuate portion. A width between the outside edges of the single lower fork is dimensioned for trenching.

In use, the skid steer loader can move the fork and jaw grapple 10 in the vertical and horizontal direction. In addition, the skid steer loader can move the fork and jaw grapple 10 from its resting position shown in FIGS. 1, 5 and 6 approximately ninety (90°) degrees clockwise or ninety (90°) degrees counterclockwise.

In one such use, the fork and jaw grapple 10 can be used to trench through concrete slabs or blacktop. When above the concrete slab, the fork and jaw grapple 10 is rotated counterclockwise or downward so that a mouth 50 of the fork and jaw grapple 10 is pointing downward toward the concrete slab or blacktop. Thereafter, the fork 11 of the fork and jaw grapple 10 may be wedged under the concrete slab and then the fork and jaw grapple 10 is rotated clockwise or upward, sliding under the concrete slab to break through it. Some surfaces, such as blacktop, may be directly broken through by the present invention. Other surfaces, such as poured concrete, which is harder, may require that saw cuts be made along the line of the trench before the “beak” or fork and jaw grapple of the present invention be used. The angle at the tips 13 of the fork 11 and the forces being applied by the skid steer loader and the fork and jaw grapple 10 facilitate the breaking through. The fork and jaw grapple 10 is then used to fully slip the fork 11 under the concrete slab at which time the second end 29 of the cylinder 25 is extended causing the jaw 12 to move downward into engagement and to hold or grab the top of concrete slab. The stops 18 prevent parts of the concrete slab from moving upward past the stops 18. The fork and jaw grapple 10 is then used to pick-up and transport the concrete slab portions to a dump truck, other vehicle or location for place down into the back of the dump truck, other vehicle or location as opposed to dumping the concrete slab into the back of the dump truck, other vehicle or location. When above the back of the dump truck, other vehicle or location, the fork and jaw grapple 10 is rotated ninety (90°) degrees counterclockwise or downward so that the mouth 50 of the fork and jaw grapple 10 holding or grasping the concrete slab is pointing downward. Thereafter, the fork and jaw grapple 10 places the concrete in contact with the back of the dump truck, other vehicle or location, and the second end 29 of the cylinder 25 retracts thereby opening the jaw 12 to release the concrete slab.

In other uses, the fork and jaw grapple 10 is slid under or into materials, such as telephone poles, pipes, posts, railroad ties, tires, scrap piles or other materials or objects. The angle at the tips 13 of the fork 11 and the forces being applied by the skid steer loader and the fork and jaw grapple 10 facilitate the insertion under or into the materials. After insertion under or into these materials, second end 29 of the cylinder 25 is extended thereby moving the jaw 12 downward into engagement and to hold the materials during pick-up, transport or placement down. The fork and jaw grapple 10 is then used to pick-up and transport the materials to a dump truck, other vehicle or location for placing down, as opposed to dumping the materials. When above the back of the dump truck, other vehicle or location, the fork and jaw grapple 10 is rotated ninety (90°) degrees counterclockwise or downward so that the mouth 40 of the fork and jaw grapple 10 holding or grasping the materials is pointing downward. Thereafter, the fork and jaw grapple 10 places the materials in contact with the back of the dump truck, other vehicle or location, and the second end 29 of the cylinder 25 retracts thereby opening the jaw 12 to release the materials.

A method of assembling a fork and jaw grapple is also disclosed. The method includes the steps of: providing a single lower fork, pivotably connecting an upper jaw to the first lower fork, and operatively connecting a hydraulic cylinder to the upper jaw.

The present invention also includes a method of using a fork and jaw grapple. The method includes the steps of: providing a fork and jaw grapple, moving the fork and jaw grapple toward the slab of concrete, engaging the lower fork with a bottom side of the slab of concrete, prying upwardly the slab of concrete, engaging the upper jaw with the slab of concrete, and lifting upwardly the slab of concrete. Optionally, the method may further include the step of placing the concrete slab into a back of a vehicle.

In view of the foregoing, it will be seen that the several advantages of the invention are achieved and attained.

As various modifications could be made in the constructions and methods herein described and illustrated without departing from the scope of the invention, it is intended that all matter contained in the foregoing description or shown in the accompanying drawings shall be interpreted as illustrative rather than limiting. For example, while in the depicted embodiments there is a single upper jaw, those skilled in the art will understand that the fork and jaw grapple may include two or more upper jaws. Thus, the breadth and scope of the present invention should not be limited by any of the above-described exemplary embodiments, but should be defined only in accordance with the following claims appended hereto and their equivalents.

What is claimed is:

1. A grapple attachment comprising:
a. a single lower fork, said a single lower fork having a longitudinally extending member with an arcuate portion located at an end portion of said longitudinally extending member such that said arcuate portion provides a fulcrum point and said longitudinally extending member provides a lever for mechanical advantage;
b. an upper jaw pivotably connected to said a single lower fork; and
c. a hydraulic cylinder operatively connected to said upper jaw, said hydraulic cylinder adapted to pivot said upper jaw relative to said a single lower fork.

2. The grapple attachment according to claim 1, wherein said a single lower fork comprises a first lower fork and a second lower fork spaced apart from said first lower fork, and wherein said upper jaw located intermediate said first lower fork and said second lower fork.

3. The grapple attachment according to claim 1, wherein said a single lower fork is L-shaped.

4. The grapple attachment according to claim 1, further comprising a stop operatively connected to said a single lower fork.

5. The grapple attachment according to claim 1, further comprising a shroud operatively connected to said upper jaw.

6. The grapple attachment according to claim 1, further comprising a back mounting bracket operatively connected to said a single lower fork.

7. The grapple attachment according to claim 1, further comprising a front mounting bracket operatively connected to said upper jaw.

8. The grapple attachment according to claim 1, wherein said upper jaw further comprises an arm having an arcuate end portion at its distal end.

9. The grapple attachment according to claim 8, wherein said arm includes a plurality of fingers.

10. The grapple attachment according to claim 1, wherein said a single lower fork further comprises an upwardly extending back member and a tapered portion operatively connected to said arcuate portion.

11. The grapple attachment according to claim 10, further comprising a tip operatively connected to said tapered portion.

12. The grapple attachment according to claim 1, further comprising a middle section connected to said a single lower fork.

13. The grapple attachment according to claim 12, wherein said middle section is L-shaped.

14. The grapple attachment according to claim 12, wherein said middle section terminates with a U-shaped section.

15. A fork and jaw grapple attachment for a machine, the fork and jaw grapple attachment comprising:
a. a first lower fork, said first lower fork having a longitudinally extending member with an arcuate portion located at an end portion of said longitudinally extending member such that said arcuate portion provides a fulcrum point and said longitudinally extending member provides a lever for mechanical advantage;
b. a second lower fork spaced apart from said first lower fork, said second lower fork with an arcuate portion located at an end portion of said longitudinally extending member such that said arcuate portion provides a fulcrum point and said longitudinally extending member provides a lever for mechanical advantage;
c. an upper jaw pivotably connected to said first lower fork and said second lower fork; and
d. a hydraulic cylinder operatively connected to said upper jaw, said hydraulic cylinder adapted to pivot said upper jaw relative to said first lower fork and said second lower fork.

16. The fork and jaw grapple attachment according to claim 15, wherein the machine has a machine frame and wherein a width between an outside edge of said first lower fork and an outside edge of said second lower fork is less than the width of the machine frame.

17. The fork and jaw grapple attachment according to claim 16, wherein said width is less than four feet.

18. The fork and jaw grapple attachment according to claim 16, wherein said width is less than three feet.

19. A skid steer loader having a machine frame, the skid steer loader comprising:
a. an attachment, said attachment comprising:
i. a single lower fork, said a single lower fork having a longitudinally extending member with an arcuate portion located at an end portion of said longitudinally extending member such that said arcuate portion provides a fulcrum point and said longitudinally extending member provides a lever for mechanical advantage;
ii. an upper jaw pivotably connected to said a single lower fork; and
iii. a hydraulic cylinder operatively connected to said upper jaw, said hydraulic cylinder adapted to pivot said upper jaw relative to said a single lower fork.

20. The skid steer loader according to claim 19, wherein said a single lower fork comprises a first lower fork and a second lower fork spaced apart from said first lower fork, and wherein said upper jaw located intermediate to said first lower fork and said second lower fork.

21. The skid steer loader according to claim 20, wherein a width between an outside edge of said first lower fork and an outside edge of said second lower fork is less than the width of the machine frame

22. The skid steer loader according to claim 21, wherein said width is less than four feet.

23. The skid steer loader according to claim 21, wherein said width is less than three feet.
